(19) United States
(12) Patent Application Publication
(10) Pub. No.: US 2024/0014655 A1
(43) Pub. Date: Jan. 11, 2024

(54) ARTIFICIAL INTELLIGENCE APPARATUS BASED ON ESS AND METHOD FOR CLUSTERING ENERGY PREDICTION MODELS THEREOF

(71) Applicant: LG ELECTRONICS INC., Seoul (KR)

(72) Inventor: Jaehong KIM, Seoul (KR)

(73) Assignee: LG ELECTRONICS INC., Seoul (KR)

(21) Appl. No.: 18/047,998

(22) Filed: Oct. 19, 2022

(30) Foreign Application Priority Data
Jul. 8, 2022 (WO) PCT/KR2022/009941

(51) Int. Cl. H02J 3/14; H02J 3/00

(52) U.S. Cl. CPC H02J 3/144; H02J 3/003

(57) ABSTRACT

system (ESS), and a method for clustering an energy prediction model thereof and may be configured to check whether a federated model for determining the similarity with the energy prediction model for each household exists in the memory if an energy prediction model for each household is received, to determine the similarity between the energy prediction model for each household and the federated model if the federated model exists, and to cluster the energy prediction model for each household into the federated model according to the determined similarity to update the federated model.

### CROSS-REFERENCE TO RELATED APPLICATION(S)

Pursuant to 35 U.S.C. § 119, this application claims the benefit of an earlier filing date and right of priority to International Application No. PCT/KR2022/009941, filed on Jul. 8, 2022, the contents of which are hereby incorporated by reference herein in its entirety.

### BACKGROUND

The present disclosure relates to an artificial intelligence apparatus capable of generating and updating a federated model by clustering an energy prediction model for each household based on an energy storage system (ESS), and a method for clustering an energy prediction model thereof.

In general, an energy storage system (ESS) refers to a device that stores energy produced from solar power, wind power, or the like, which are new and renewable energy markets, in a storage device (for example, a battery) and then supplies electricity at a required time to improve power use efficiency.

It is important for the energy storage system (ESS) to accurately predict power production and power consumption generated in the home for energy efficiency.

An energy storage system (ESS) for household uses an energy prediction model for household that learns to predict the power production and consumption by collecting data generated in the home in order to accurately predict the power production and power consumption in the home.

However, since the energy prediction model for household is learned using only limited data within the household, there is a problem in that the performance error of the energy prediction model increases when the energy usage pattern of the household is partially changed.

As such, when energy usage patterns are different for each household, there may a problem that a local model generated based on data collected for each household is provided, but the local model is over-fitting because the number of data collected for each household is small.

Therefore, it is necessary to develop a technology capable of providing a model capable of accurately predicting various usage patterns by federatedly learning energy prediction models (local models) for each household having a similar energy usage pattern in the same region in the future.

### SUMMARY

An object of the present disclosure is to solve the above problems and other problems.

An object of the present disclosure is to provide an artificial intelligence apparatus capable of generating and updating a federated model that can accurately predict even various usage patterns by federatedly learning energy prediction models for each household having a similar energy usage pattern in the same region, and a method for clustering energy prediction model thereof.

In addition, an object of the present disclosure is to provide an artificial intelligence apparatus capable of improving service performance and quality by distributing and managing a model by federating energy data of households with similar patterns in the same region, and a method for clustering energy prediction model thereof.

An artificial intelligence apparatus according to an embodiment of the present disclosure may include a memory configured to store at least one federated model; and, a processor configured to generate and update the federated model, in which the processor may be configured to check whether a federated model for determining the similarity with the energy prediction model for each household exists in the memory if an energy prediction model for each household is received, to determine the similarity between the energy prediction model for each household and the federated model if the federated model exists, and to cluster the energy prediction model for each household into the federated model according to the determined similarity to update the federated model.

A method for clustering a energy prediction model of an artificial intelligence device according to an embodiment of the present disclosure may include receiving an energy prediction model for each household; checking whether a federated model for determining similarity with the energy prediction model for each household exists in the memory; determining the similarity between the energy prediction model for each household and the federated model if the federated model exists; and clustering the energy prediction model for each household into the federated model corresponding to the determined similarity to update the federated model.

According to an embodiment of the present disclosure, an artificial intelligence apparatus can generate and update a federated model that can accurately predict even various usage patterns by federatedly learning energy prediction models for each household having a similar energy usage pattern in the same region.

In addition, according to an embodiment of the present disclosure, the artificial intelligence apparatus may federatedly distribute and manage a model energy data of a household having similar patterns within the same region to improve service performance and quality.

### BRIEF DESCRIPTION OF THE DRAWINGS

FIG. 1 is a view illustrating an artificial intelligence apparatus according to an embodiment of the present disclosure.

FIG. 2 is a view illustrating an artificial intelligence server according to an embodiment of the present disclosure.

FIG. 3 illustrates an artificial intelligence apparatus applied to an energy storage system (ESS) according to an embodiment of the present disclosure.

FIG. 4 is a diagram for explaining a process of clustering an energy prediction model of an artificial intelligence apparatus according to an embodiment of the present disclosure.

FIG. 5 is a diagram for explaining a process of updating a federated model of an artificial intelligence apparatus according to an embodiment of the present disclosure.

FIGS. 6 and 7 are diagrams for explaining a dot product and comparison process of an energy prediction model and a single federated model according to an embodiment of the present disclosure.

FIG. 8 is a diagram for explaining an update process of a federated model according to an embodiment of the present disclosure.

FIG. 9 is a diagram for explaining a dot product and comparison process of an energy prediction model and a plurality of federated models according to an embodiment of the present disclosure.

FIGS. 10 to 12 are flowcharts illustrating a method for clustering an energy prediction model of an artificial intelligence apparatus according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

Also, throughout this specification, a neural network, a neural network network, and a network function may be used interchangeably. A neural network may be composed of a set of interconnected computational units, which may be generally referred to as “nodes”. These “nodes” may also be referred to as “neurons”. A neural network is configured to include at least two or more nodes. Nodes (or neurons) constituting the neural networks may be interconnected by one or more “links”.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

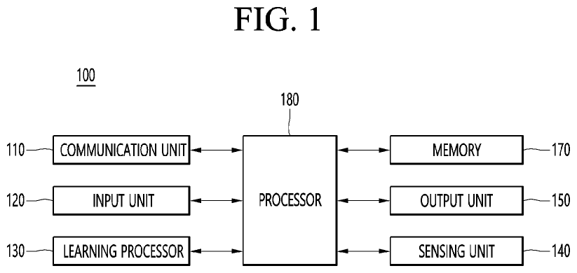

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and u ser information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI device 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

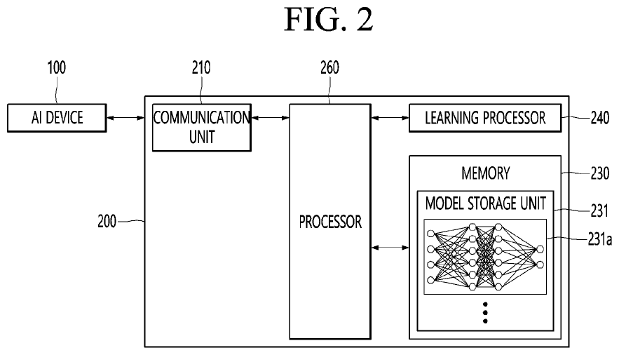

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

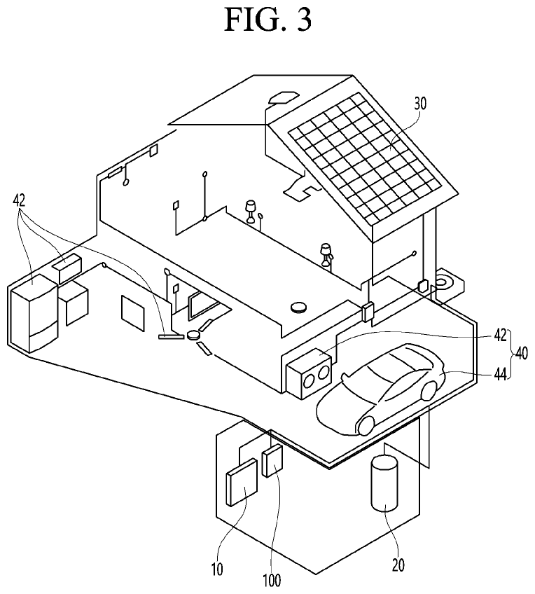

FIG. 3 illustrates an artificial intelligence apparatus applied to an energy storage system (ESS) according to an embodiment of the present disclosure.

As shown in FIG. 3, the energy storage system may include a battery module including a plurality of battery cells, a power storage station 20, a power generating station including a solar panel, and an artificial intelligence apparatus 100 for predicting power production and power consumption generated in the household.

In addition, the artificial intelligence apparatus 100 may predict the power consumption in the home based on power consumption data for the electronic device 40 in the home.

Here, the electronic device 40 in the home may include a fixed electronic device 42 such as a refrigerator, a washing machine, a light, a fan, and the like, and a mobile electronic device 44 such as an electric vehicle or an electric bike.

In addition, the artificial intelligence apparatus 100 may predict the power production and the power consumption generating in the home based on the energy data in the home based on the energy prediction model.

Next, the artificial intelligence apparatus 100 may federate and learn an energy prediction model for each household having a similar energy usage pattern from energy storage systems of other households located within the same region.

Here, when the artificial intelligence apparatus 100 receives an energy prediction model for each household, based on the similarity between the energy prediction model for each household and the federated model, the artificial intelligence apparatus 100 may cluster the energy prediction model for each household into a federated model and may update the federated model.

The artificial intelligence apparatus 100 may receive an energy prediction model for each household from an energy storage system (ESS) of each household located within the same region.

Then, the artificial intelligence apparatus 100 may perform the dot product and the comparison of the vector of the energy prediction model for each household and the vector of the federated model to determine the similarity therebetween.

For example, if the angle θ between the vector of the energy prediction model and the vector of the federated model is 0≤θ<90, the artificial intelligence apparatus 100 may determine that the energy prediction model and the federated model are similar to each other.

As another example, if the angle θ between the vector of the energy prediction model and the vector of the federated model is equal to or greater than 90 degrees, the artificial intelligence apparatus 100 may determine that the energy prediction model and the federated model are different from each other.

Here, if the artificial intelligence apparatus 100 determines that the energy prediction model and the federated model are different from each other, the artificial intelligence apparatus 100 may generate a new federated model based on the input energy prediction model.

Next, the artificial intelligence apparatus 100 may cluster the input energy prediction model into a federated model if the energy prediction model and the federated model are similar and update the federated model through vector synthesis of the input energy prediction model and the federated model.

In other words, the artificial intelligence apparatus 100 may cluster the input energy prediction model into the federated model if the input energy prediction model is similar to the existing energy prediction models for each household clustered into the federated model.

As such, the artificial intelligence apparatus 100 of the present disclosure can generate and update a federated model that can accurately predict various usage patterns by federatedly learning energy prediction models for each household having a similar energy usage pattern in the same region.

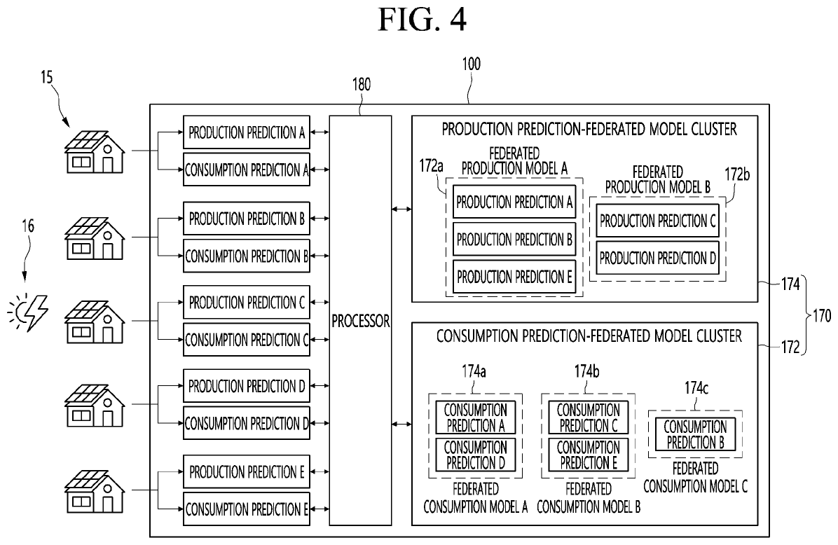

FIG. 4 is a diagram for explaining a process of clustering an energy prediction model of an artificial intelligence apparatus according to an embodiment of the present disclosure.

As shown in FIG. 4, the artificial intelligence apparatus 100 of the present disclosure may include a memory 170 for storing at least one federated model, and a processor 180 for generating and updating the federated model.

If the processor 180 of the artificial intelligence apparatus 100 receives an energy prediction model for each household, the processor 180 of the artificial intelligence apparatus 100 checks whether there is a federated model for determining the similarity with the energy prediction model for each household in the memory 170, and if there is the federated model, the processor may determine the similarity between the energy prediction model for each household and the federated model, cluster the energy prediction model for each household into the federated model corresponding to the determined similarity, and update the federated model.

Here, the processor 180 may receive an energy prediction model for each household from an energy storage system (ESS) of each household 15 located in the same region.

In other words, the processor 180 may receive an energy prediction model for each household from the ESS of each household 15 located within the same region as the natural environment.

For example, the processor 180 may receive an energy prediction model for each household from the ESS of each household 15 located in the same region having the same weather 16 including temperature and sunshine.

As such, the present disclosure may federate local models of households 15 having similar energy usage patterns located in regions with the same environment.

In addition, the energy prediction model for each household may include a plurality of parameters for predicting the power production and power consumption of each household 15, but this is only an example and is not limited thereto.

Next, when the processor 180 checks whether there is the federated model in the memory 170, if there is not the federated model in the memory 170, the processor 180 generates a new federated model based on the input energy prediction model to store the new federated model to the memory 170.

In other words, when there is no federated model that can be compared with the input energy prediction model, the processor 180 may generate the first new federated model based on the input energy prediction model.

As an example, the generated new federated model may be the first federated model stored in the memory 170, and the first federated model may be the same as the input energy prediction model.

In addition, the processor 180 may generate a new federated model that provides a prediction result of the same category as a category corresponding to the prediction result of the input energy prediction model.

For example, if the category corresponding to the prediction result of the input energy prediction model is the power production prediction, the processor 180 may generate a new federated model that provides a prediction result corresponding to the power production prediction, and If the category corresponding to the prediction result of the input energy prediction model is a power consumption prediction, the processor 180 may generate a new federated model that provides a prediction result corresponding to the power consumption prediction.

Next, when the processor 180 checks whether there is the federated model in the memory 170, if there is the federated model in the memory 170, the processor 180 may check whether the federated model stored in the memory 170 is one or more, and if the federated model stored in the memory 170 is one, the processor 180 may determine the similarity between the input energy prediction model and one federated model by comparing the input energy prediction model with one federated model.

Here, when the processor determines the degree of similarity, the processor 180 may perform the dot product and the comparison of the vector of the input energy prediction model and the vector of one federated model to determine the similarity between the vector of the input energy prediction model and the vector of one federated model.

For example, if the angle θ between the vector of the input energy prediction model and the vector of one federated model is 0≤θ<90, the processor 180 may determine that the input energy prediction model and the one federated model are similar to each other.

In other words, the processor 180 may determines that the similarity between the input energy prediction model and the one federated model increases as the angle θ between the vector of the input energy prediction model and the vector of one federated model is closer to 0 degrees, and the processor 180 may determine that the similarity between the input energy prediction model and the one federated model decreases as the angle θ between the vector of the input energy prediction model and the vector of the one federated model is closer to 90 degrees.

In addition, if the processor 180 determines that the input energy prediction model and one federated model are similar to each other, the processer 180 may determine that the category corresponding to the prediction result of the input energy prediction model and the category corresponding to the prediction result of the federated model are the same.

For example, when the category corresponding to the prediction result of the input energy prediction model is the power production prediction, the processor 180 may determine one federated model stored in the memory 170 as a federated model having a category corresponding to the power consumption prediction.

As another example, when the category corresponding to the prediction result of the input energy prediction model is the power consumption prediction, the processor 180 may determine one federated model stored in the memory 170 as the federated model having a category corresponding to the power production prediction.

In addition, if the angle θ between the vector of the input energy prediction model and the vector of the one federated model is 90 degrees or more, the processor 180 may determine that the input energy prediction model and the one federated model are different from each other.

Here, if the processor 180 determines that the input energy prediction model and one federated model are different from each other, the processor 180 may generate a new federated model based on the input energy prediction model and store the new federated model in the memory 170.

For example, the generated new federated model may be a new federated model different from the existing federated model stored in the memory, and the new federated model may be the same as the input energy prediction model.

In addition, the processor 180 may generate a new federated model that provides a prediction result of the same category as a category corresponding to the prediction result of the input energy prediction model.

For example, if the category corresponding to the prediction result of the input energy prediction model is the power production prediction, the processor 180 may generate a new federated model that provides a prediction result corresponding to the power production prediction, and if the category corresponding to the prediction result of the input energy prediction model is the power consumption prediction, the processor 180 may generate a new federated model that provides a prediction result corresponding to the power consumption prediction.

Next, if there are a plurality of federated models stored in the memory 170, the processor 180 may compare the input energy prediction model with a plurality of federated models, determine the similarity between the input energy prediction model and a plurality of federated models, and select the federated model of the plurality of federated models having the highest similarity.

Here, when the processor 180 determines the similarity, the processor 180 may perform the dot product and the comparison of the vector of the input energy prediction model and all vectors corresponding to the plurality of federated models, respectively, to determine the similarity between the vector of the input energy prediction model and all vectors corresponding to the plurality of federated models.

For example, if the angle θ between the vector of the input energy prediction model and the vector of the federated model is 0≤θ<90, the processor 180 may determine that the input energy prediction model and the federated model are similar to each other.

In other words, the processor 180 may determine that the similarity between the input energy prediction model and the federated model increases as the angle θ between the vector of the input energy prediction model and the vector of the federated model is closer to 0 degrees and may determine that the similarity between the input energy prediction model and the federated model decreases as the angle θ between the vector of the energy prediction model and the vector of the federated model is closer to 90 degrees.

Then, if the processor 180 extracts a plurality of federated models similar to the input energy prediction model and selects a federated model of a plurality of extracted federated model which is determined to be most similar to the input energy prediction model, the processor may determine that the category corresponding to the prediction result of the input energy prediction model and the category corresponding to the prediction result of the selected federated model are the same.

For example, when the category corresponding to the prediction result of the input energy prediction model is the power production prediction, the processor 180 may determine the selected federated model as a federated model having a category corresponding to the power consumption prediction.

As another example, when the category corresponding to the prediction result of the input energy prediction model is the power consumption prediction, the processor 180 may determine the selected federated model as a federated model having a category corresponding to the power production prediction.

In addition, if the angle θ between the vector of the input energy prediction model and the vectors of all the associated models is equal to or greater than 90 degrees, the processor 180 may determine that the input energy prediction model and all the associated models are different from each other.

Here, if the processor 180 determines that the input energy prediction model and all the federated models are different from each other, the processor 180 may generate a new federated model based on the input energy prediction model and store the new federated model in the memory 170.

For example, the generated new federated model may be a new federated model different from the existing federated models stored in the memory 170, and the new federated model may be the same as the input energy prediction model.

In addition, the processor 180 may generate a new federated model that provides a prediction result of the same category as a category corresponding to the prediction result of the input energy prediction model.

For example, if the category corresponding to the prediction result of the input energy prediction model is the power production prediction, the processor 180 generates a new federated model that provides a prediction result corresponding to the power production prediction, and If the category corresponding to the prediction result is a power consumption prediction, a new federated model that provides a prediction result corresponding to the power consumption prediction may be generated.

Next, when the processor 180 updates the federated model and, as a result of the similarity determination, if there is a federated model similar to the input energy prediction model in the memory 170, the processor 180 may cluster the input energy prediction model into the federated model and may update the federated model through vector synthesis of the input energy prediction model and the federated model.

As an example, the federated model may be a model in which a plurality of energy prediction models for each household with high similarity are clustered, and the processor 180 may cluster the input energy prediction model into a federated model if the input energy prediction model is similar to the existing energy prediction models for each household clustered into a federated model.

In addition, when the processor 180 updates the federated model, the processor 180 may calculate a synthesis vector through synthesis of the vector of the input energy prediction model and the vector of the federated model and update the federated model based on the calculated synthesis vector.

Subsequently, the processor 180 may store the updated federated model in the memory 170 when the federated model is updated.

For example, when updating the federated model, the processor 180 may update the federated model based on a project conflicting gradients (PCGrad) algorithm.

Here, since the project conflicting gradients (PCGrad) algorithm is difficult to learn if the gradient of each task and the gradient of other tasks during multi-task learning conflict, the project conflicting gradients (PCGrad) algorithm is an algorithm that makes it possible to optimize the learning of multi-tasks by performing the projection of each gradient and updating the gradient in a direction that compromises each other.

Accordingly, when the processor 180 of the present disclosure updates the federated model, if the angle θ between the vector of the input energy prediction model and the vector of the federated model is 0≤0<90, a synthesized vector may be calculated by synthesizing the vector of the input energy prediction model and the vector of the association model, and the association model may be updated based on the calculated synthesized vector.

If the angle θ between the vector of the input energy prediction model and the vector of the federated model pre-stored in the memory 170 is 0≤θ<90, The processor 180 of the present disclosure may determine that the vector of the input energy prediction model and the vector of the federated model are similar to each other, cluster the input energy prediction model into the federated model, and update the federated model based on the synthesis vector through the synthesis of the vector of the input energy prediction model and the vector of the federated model.

In addition, if the angle θ between the vector of the input energy prediction model and the vector of the federated model pre-stored in the memory 170 is equal to or greater than 90 degrees, the processor 180 of the present disclosure determines that the vector of the input energy prediction model and the vector of the federated model are not similar to each other and thus the input energy prediction model can be generated and stored as a new federated model.

In addition, the processor 180 of the present disclosure may generate and store the input energy prediction model as a new federated model if the federated model to be compared with the input energy prediction model is not stored.

As such, the present disclosure can improve the performance and quality of the energy prediction service for each household by generating a federated model by federating a plurality of similar energy prediction models for each household and updating the federated model.

Next, in the memory 170 of the present disclosure, at least one federated model in which a plurality of energy prediction models for each household with high similarity are clustered may be stored.

Here, the memory 170 of the present disclosure may separate and store the federated models for each category of the prediction result provided by the federated model when there are a plurality of stored federated models.

As an example, the memory 170 of the present disclosure may include a first federated model cluster 172 including a plurality of first federated models 172a and 172b providing a prediction result of a first category, and a second federated model cluster 174 including a plurality of second federated models 172a, 174b, 174c that provide a prediction result of a second category.

For example, in each of the first federated models 172a and 172b, similar energy prediction models of the energy prediction models for each household that provide the prediction result of the first category may be clustered, and in each second federated model 172a, 174b, and 174c, similar energy prediction models of the energy prediction models for each household that provide the prediction result of the second category may be clustered.

In the first federated model cluster 172, a plurality of federated power production models providing a power production prediction result may be clustered, and in each federated power production model, a plurality of power production prediction models for each household with high similarity may be clustered.

For example, as shown in FIG. 4, in the first federated model cluster 172, the federated power production model A and the federated power production model B may be clustered.

Here, in the federated power production model A, power production prediction models A, B, and E for each household having a first power production pattern similar to each other may be clustered and in the federated power production model B, power production prediction models C and D for each household having a second power production pattern similar to each other may be clustered.

In addition, in the second federated model cluster 174, a plurality of federated power consumption models that provide a power consumption prediction result may be clustered, and in each federated power consumption model, a plurality of power consumption prediction models for each household with high similarity may be clustered.

For example, as shown in FIG. 4, in the second federated model cluster 174, the federated power consumption model A, the federated power consumption model B, and the federated power consumption model C may be clustered.

Here, in the federated power consumption model A, power consumption prediction models A and D for each household having a first power consumption pattern similar to each other may be clustered, and, in the federated power consumption model B, the power production prediction models C and E having a second power consumption pattern similar to each other may be clustered, and the power production prediction model B for each household having a third power consumption pattern may be clustered.

Throughout this specification, the terms neural network, network function, and neural network may be used interchangeably.

The above-described neural network model may be an artificial neural network (ANN) trained to output reconstructed data close to the input data with respect to the input data. The artificial neural network (ANN) is a model used in machine learning, and may refer to an overall model having problem-solving ability, which is composed of artificial neurons (nodes) that form a network by combining synapses.

For example, the neural network model may be an autoencoder-based artificial neural network model. The autoencoder-based neural network model may include a encoder portion which dimensionally reduces the data by making the number of neurons in the hidden layer smaller than the number of neurons in the input layer, and a decoder portion which reconstructs the data by dimensionally expanding the data from the hidden layer again and has an output layer having the same number of of neurons as the number of neurons in the input layer, but not limited thereto.

In addition, the neural network model may be an artificial neural network model based on a generative adversarial network (GAN). The generative adversarial network (GAN) may be an artificial neural network in which a generator and a discriminator are adversarially learned, but is not limited thereto.

In addition, the neural network model may be a deep neural network. A deep neural network (DNN) may refer to a neural network including a plurality of hidden layers in addition to an input layer and an output layer. Deep neural networks can be used to understand the latent structures of data. In other words, it can understand the potential structure of photos, texts, videos, voices, and music (e.g., what objects are in the photos, what is the content and emotion of the text, what is the content and emotion of the voice, or the like). A deep neural network may include a convolutional neural network (CNN), a recurrent neural network (RNN), a restricted boltzmann machine (RBM), and a deep belief network (DBN), Q network, U network, Siamese network, and the like.

As such, the artificial intelligence apparatus of the present disclosure can generate and update a federated model capable of accurately predicting various usage patterns by federatedly learning energy prediction models for each household having similar energy usage patterns in the same region.

In addition, the artificial intelligence apparatus of the present disclosure can improve service performance and quality by distributing and managing a model by federating energy data of households having similar patterns in the same region.

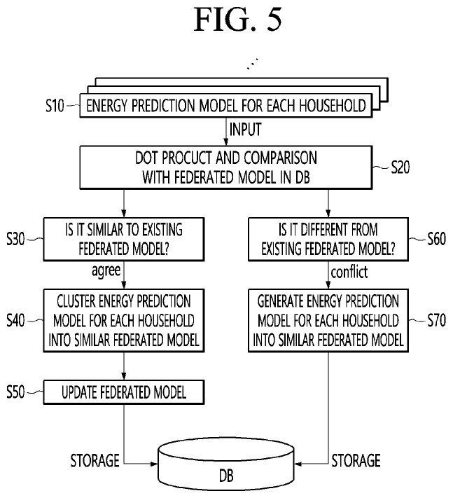

FIG. 5 is a diagram for explaining a process of updating a federated model of an artificial intelligence apparatus according to an embodiment of the present disclosure.

As shown in FIG. 5, in the present disclosure, an energy prediction model for each household may be received (S10).

Here, the energy prediction model for each household may include a plurality of parameters for predicting the power production and power consumption of each household.

In addition, the energy prediction model for each household may be received from the ESS of each household located within the regions having the same natural environment.

As an example, the energy prediction model for each household may be received from the ESS of each household located in the same region having the same weather including temperature and sunshine.

As such, the reason for receiving an energy prediction model for each household from the ESS of each household located in the regions having the same natural environment is to federate local models of households located in a region having the same environment and having similar energy usage patterns.

Next, according to the present disclosure, it is possible to determine the similarity between the input energy prediction model for each household and the federated model pre-stored in the database through the dot product and the comparison of the input energy prediction model for each household and the federated model pre-stored in the database (S20).

Here, in the present disclosure, if the angle θ between the vector of the input energy prediction model for each household and the vector of the federated model is 0≤θ<90, it may be determined that the input energy prediction model for each household and the pre-stored federated model are similar to each other.

In other words, when the gradients of the two models do not agree with each other, according to the present disclosure, since the cosine similarity is positive, it may be determined that the two models are similar to each other.

In the present disclosure, when it is determined that the input energy prediction model for each household and the federated model are similar to each other, it may be determined that the category corresponding to the prediction result of the input energy prediction model for each household and the category corresponding to the prediction result of the federated model are the same.

As an example, in the present disclosure, if a category corresponding to the prediction result of the input energy prediction model for each household is a power production prediction, the federated model may be determined as a federated model having a category corresponding to the power consumption prediction, and if the category corresponding to the prediction result of the input energy prediction model for each household is the power consumption prediction, the federated model may be determined as a federated model having a category corresponding to the power production prediction.

In addition, according to the present disclosure, if the angle θ between the vector of the input energy prediction model for each household and the vector of the federated model is 90 degrees or more, it may be determined that the input energy prediction model for each household and the pre-stored federated model are different from each other.

In other words, in a case where the gradients of the two models conflict with each other, the present disclosure may determine that the two models are different from each other because cosine similarity is negative.

Next, in the present disclosure, when it is determined that the input energy prediction model for each household and the pre-stored federated model are similar to each other (S30), the input energy prediction model for each household may be clustered into the federated model (S40).

Here, in the present disclosure, in a case where there are a plurality of pre-stored federated models, by comparing the input energy prediction model for each household and a plurality of federated models, the similarity between the input energy prediction model for each household and a plurality of federated models is determined, the federated model of the plurality of federated models having the highest similarity is selected, and thus the input energy prediction model for each household may be clustered into the selected federated model.

In addition, according to the present disclosure, the federated model may be updated through vector synthesis of the input energy prediction model for each household and the federated model (S50).

Here, in the present disclosure, when the federated model is updated, a synthesis vector may be calculated through synthesis of the vector of the input energy prediction model for each household and the vector of the federated model, and the federated model may be updated based on the calculated synthesis vector.

Subsequently, the present disclosure may store the updated federated model in a database when the federated model is updated.

Meanwhile, in the present disclosure, when it is determined that the input energy prediction model for each household and the pre-stored federated model are different from each other (S60), a new federated model may be generated based on the input energy prediction model for each household and the new federated model may be stored in the database (S70).

Here, the present disclosure compares the input energy prediction model for each household and a plurality of federated models in a case where there are a plurality of pre-stored federated models and determines the similarity between the input energy prediction model for each household and a plurality of federated models, and if it is determined that the input energy prediction model for each household and all federated models are different from each other, a new federated model can be generated based on the input energy prediction model for each household.

In this case, the present disclosure may generate a new federated model that provides a prediction result of the same category as a category corresponding to the prediction result of the input energy prediction model for each household.

For example, in the present disclosure, if a category corresponding to the prediction result of the input energy prediction model for each household is a power production prediction, a new federated model that provides a prediction result corresponding to the power production prediction may be generated, and if the category corresponding to the prediction result of the input energy prediction model for each household is the power consumption prediction, a new federated model that provides the prediction result corresponding to the power consumption prediction may be generated.

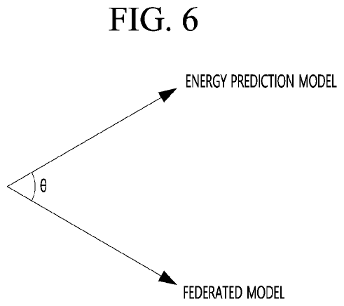

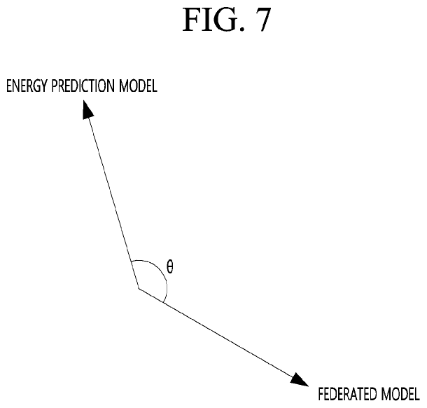

FIGS. 6 and 7 are diagrams for explaining an dot product comparison process between an energy prediction model and a single federated model according to an embodiment of the present disclosure.

As shown in FIGS. 6 and 7, the present disclosure may perform the dot product and the comparison of the vector of the input energy prediction model and the vector of the federated model to determine similarity therebetween.

As an example, as shown in FIG. 6, in the present disclosure, if the angle θ between the vector of the input energy prediction model and the vector of the federated model is 0≤θ<90, it may be determined that the input energy prediction model and the federated model are similar to each other.

In other words, in the present disclosure, it is determined that the similarity between the input energy prediction model and the federated model increases as the angle θ between the vector of the input energy prediction model and the vector of the federated model is closer to 0 degrees, and as the angle θ between the vector of input energy prediction model and the vector of the federated model is closer to 90 degrees, it may be determined that the similarity between the input energy prediction model and the federated model decreases.

As another example, as shown in FIG. 7, in the present disclosure, if the angle θ between the vector of the input energy prediction model and the vector of the federated model is 90 degrees or more, it may be determined that the input energy prediction model and the federated model are different from each other.

Here, in the present disclosure, if it is determined that the input energy prediction model and the federated model are different from each other, a new federated model may be generated based on the input energy prediction model.

For example, the generated new federated model may be a new federated model different from the existing federated model, and the new federated model may be the same as the input energy prediction model.

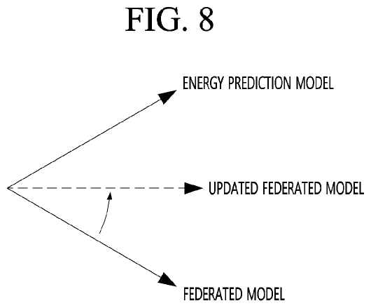

FIG. 8 is a diagram for explaining an update process of a federated model according to an embodiment of the present disclosure.

As shown in FIG. 8, in the present disclosure, if the angle θ between the vector of the input energy prediction model and the vector of the federated model is 0≤θ<90, it may be determined that the vector of the input energy prediction model and the vector of the federated model are similar to each other, the input energy prediction model may be clustered into the federated model, and through the synthesis of the vector of the input energy prediction model and the vector of the federated model, the federated model may be updated based on the synthesis vector.

As an example, the present disclosure may update the federated model based on a project conflicting gradients (PCGrad) algorithm when the federated model is updated.

Here, since the project conflicting gradients (PCGrad) algorithm is difficult to learn if the gradient of each task and the gradient of other tasks conflict during multi-task learning, the project conflicting gradients (PCGrad) algorithm is an algorithm that makes it possible to optimize the learning of multi-tasks by performing the projection of each gradient and updating the gradient in a direction that compromises each other.

As such, the present disclosure can improve the performance and quality of the energy prediction service for each household by generating a federated model by federating a plurality of similar energy prediction models for each household and updating the federated model.

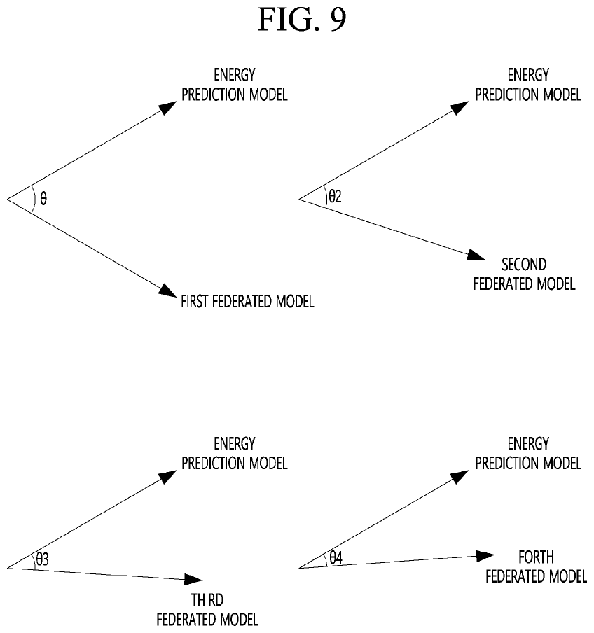

FIG. 9 is a diagram for explaining an dot product comparison process between an energy prediction model and a plurality of federated models according to an embodiment of the present disclosure.

As shown in FIG. 9, the present disclosure may compare the input energy prediction model with a plurality of federated models to determine the similarity between input energy prediction model and a plurality of federated models if there are a plurality of pre-stored federated models, and a federated model of the plurality of federated models having the highest similarity may be selected, and the input energy prediction model may be clustered into the selected federated model.

Here, the present disclosure may perform the dot product and the comparison of the vector of the input energy prediction model and all vectors corresponding to the plurality of federated models, respectively, to determine the similarity between the vector of the input energy prediction model and all vectors corresponding to the plurality of federated models.

As an example, in the present disclosure, if the angle θ between the vector of the input energy prediction model and the vector of the federated model is 0≤θ<90, it may be determined that the input energy prediction model and the federated model are similar to each other.

In other words, in the present disclosure, it may be determined that the similarity between the input energy prediction model and the federated model increases as the angle θ between the vector of the input energy prediction model and the vector of the federated model is closer to 0 degrees, and as the angle θ between the vector of the input energy prediction model and the vector of the federated model is closer to 90 degrees, it may be determined that the similarity between the input energy prediction model and the federated model decreases.

As shown in FIG. 9, when there is a plurality of federated models including the first to fourth federated models, the input energy prediction model may perform the dot product and the comparison of the first to fourth federated models, respectively.

For example, when the angle θ1 between the vector of the input energy prediction model and the vector of the first federated model, the angle θ2 between the vector of the input energy prediction model and the vector of the second federated model, the angle θ3 between the vector of the input energy prediction model and the vector of the third federated model, and the angle θ4 between the vector of the input energy prediction model and the vector of the fourth federated model are 0≤θ<90, in the present disclosure, since the angle θ4 between the vector of the input energy prediction model and the vector of the four federated models is closest to 0 degrees, it may be determined that the similarity between the input energy prediction model and the fourth federated model is the highest.

Accordingly, according to the present disclosure, a fourth federated model of the first to fourth federated models having the highest similarity may be selected, and the input energy prediction model may be clustered into the selected fourth federated model.

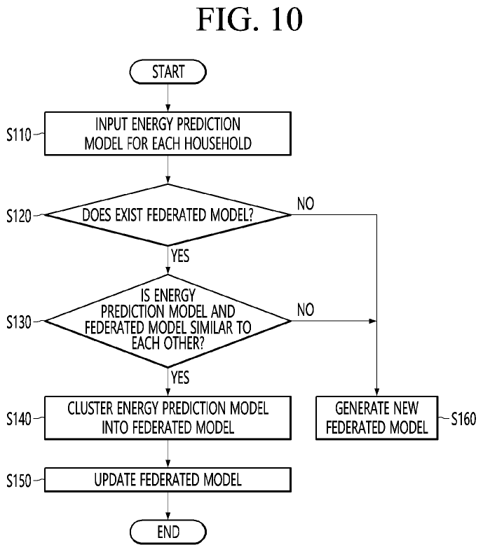

FIGS. 10 to 12 are flowcharts illustrating a method for clustering an energy prediction model of an artificial intelligence apparatus according to an embodiment of the present disclosure.

As shown in FIG. 10, in the present disclosure, an energy prediction model for each household may be input (S110).

Here, the present disclosure may receive an energy prediction model for each household from an energy storage system (ESS) of each household located in the same region.

In addition, according to the present disclosure, it can be checked whether there is a pre-stored federated model for determining the similarity with the energy prediction model for each household (S120).

Next, the present disclosure may generate a new federated model based on the input energy prediction model when there is no pre-stored federated model (S160), and may be determined whether the energy prediction model for each household and the federated model are similar to each other when there is the pre-stored federated model (S130).

Here, in the present disclosure, if the angle θ between the vector of the input energy prediction model and the vector of the federated model is 0≤θ<90 by performing the dot product and the comparison of the vector of the input energy prediction model and the vector of the federated model, the input energy prediction model and one federated model may be determined to be similar to each other.

In addition, in the present disclosure, if the angle θ between the vector of the input energy prediction model and the vector of the federated model is 90 degrees or more by performing the dot product and the comparison of the vector of the input energy prediction model and the vector of the federated model, the input energy prediction model and the federated model may be determined to be different from each other.

Next, in the present disclosure, if the energy prediction model for each household and the federated model are different, a new federated model is generated based on the input energy prediction model (S160), and if the energy prediction model for each household and the federated model are similar to each other, the energy prediction model for each household may be clustered into a federated model (S140).

In addition, the present disclosure may update the federated model (S150).

Here, the present disclosure may update the federated model through vector synthesis of the input energy prediction model and the federated model.

In other words, according to the present disclosure, a synthesis vector may be calculated through synthesis of a vector of an input energy prediction model and a vector of the federated model, and the federated model may be updated based on the calculated synthesis vector.

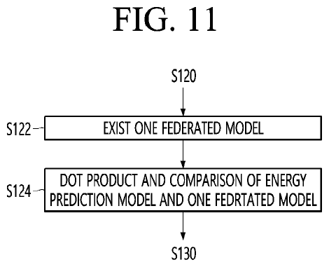

As shown in FIG. 11, in the present disclosure, in step S120 of checking whether there is a pre-stored federated model, if there is a pre-stored federated model, it can be checked whether there is one pre-stored federated model (S122).

In addition, according to the present disclosure, if there is one pre-stored federated model, the similarity between the input energy prediction model and one federated model may be determined by comparing the input energy prediction model with one federated model (S124).

Here, in the present disclosure, if the angle θ between the vector of the input energy prediction model and the vector of one federated model is 0≤θ<90, by performing the dot product and the comparison of the vector of the input energy prediction model and the vector of one federated model, it may be determined that the input energy prediction model and one federated model are similar to each other.

In addition, in the present disclosure, if the angle θ between the vector of the input energy prediction model and the vector of one federated model is 90 degrees or more by performing the dot product and the comparison of the vector of the input energy prediction model and the vector of one federated model, it may be determined that the input energy predictive model and one federated model are different from each other.

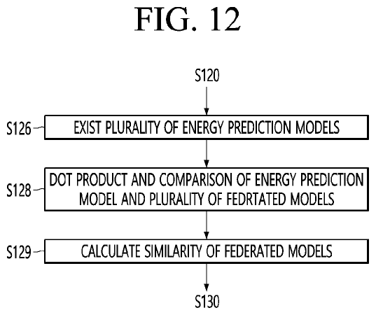

In addition, as shown in FIG. 12, in the present disclosure, in step S120 of checking whether there is a pre-stored federated model, if there is a pre-stored federated model, it can be checked whether there are a plurality of pre-stored federated models (S126).

In addition, according to the present disclosure, if there are a plurality of pre-stored federated models, the similarity between the input energy prediction model and the plurality of federated models may be determined by comparing the input energy prediction model with the plurality of federated models (S128).

Next, the present disclosure may calculate individual similarities for a plurality of federated models so that a federated model of the plurality of federated models having the highest similarity can be selected (S129).

Here, in the present disclosure, if the angle θ between the vector of the input energy prediction model and the vector of the federated model is 0≤θ<90 by performing the dot product and the comparison of the vector of the input energy prediction model and all vectors corresponding to the plurality of federated models, respectively, it may be determined that the input energy prediction model and the federated model are similar to each other.

In addition, according to the present disclosure, if the angle θ between the vector of the input energy prediction model and all vectors corresponding to the plurality of federated models is 90 degrees or more by performing the dot product and the comparison of the vector of the input energy prediction model and all vectors corresponding to the plurality of federated models, respectively, it may be determined that the input energy prediction model and all federated models are different from each other.

As such, the present disclosure can generate and update a federated model capable of accurately predicting various usage patterns by federatedly learning energy prediction models for each household having a similar energy usage pattern in the same region.

In addition, according to the present disclosure, service performance and quality can be improved by distributing and managing a model by federating energy data of households having similar patterns in the same region.

According to the artificial intelligence apparatus according to the present disclosure, by federatedly learning energy prediction models for each household having a similar energy usage pattern in the same region, since there is an effect that a federated model that can accurately predict various usage patterns can be generated and updated, industrial applicability is remarkable.

What is claimed is:

1. An artificial intelligence apparatus comprising:
a memory; and
a processor configured to:
based on receiving a plurality of energy prediction models comprising an energy prediction model for each household, determine whether a federated model exists in the memory for determining a similarity between the energy prediction model for each household and the federated model;
determine the similarity between the energy prediction model for each household and the federated model based on determining that the federated model exists in the memory; and
cluster the energy prediction model for each household into the federated model according to the determined similarity to update the federated model.

2. The artificial intelligence apparatus of claim 1,
wherein the processor is further configured to receive the plurality of energy prediction models comprising the energy prediction model for each household from an energy storage system (ESS) of each household located within a same area.

3. The artificial intelligence apparatus of claim 1,
wherein the processor is further configured to, based on determining that the federated model does not exist in the memory, generate a new federated model to be stored in the memory based on an input energy prediction model.

4. The artificial intelligence apparatus of claim 1,
wherein the processor is further configured to:
based on determining that the federated model exists in the memory, determine whether one or more federated models are stored in the memory when the processor determines whether the federated model exists in the memory; and
based on determining that there is one federated model stored in the memory, determine a similarity between an input energy prediction model and the one federated model by comparing the input energy prediction model and the one federated model.

5. The artificial intelligence apparatus of claim 4,
wherein the processor is further configured to determine a similarity between a vector of the input energy prediction model and a vector of the one federated model by performing a dot product and comparison of the vector of the input energy prediction model and the vector of the one federated model.

6. The artificial intelligence apparatus of claim 5,
wherein the processor is further configured to, based on determining that the input energy prediction model and the one federated model are different from each other, generate a new federated model to be stored in the memory, based on the input energy prediction model.

7. The artificial intelligence apparatus of claim 4,
wherein the processor is further configured to:
determine a similarity between the input energy prediction model and each of a plurality of federated models by comparing the input energy prediction model and each of the plurality of federated models; and
select a federated model of the plurality of federated models having a highest similarity with respect to the input energy prediction model.

8. The artificial intelligence apparatus of claim 7,
wherein the processor is further configured to determine a similarity between a vector of the input energy prediction model and each of a plurality of vectors corresponding to the plurality of federated models by performing a dot product and comparison of the vector of the input energy prediction model and each of the plurality of vectors corresponding to the plurality of federated models.

9. The artificial intelligence apparatus of claim 8,
wherein the processor is further configured to, based on determining that the input energy prediction model and all of the plurality of federated models are different from each other, generate a new federated model to be stored in the memory, based on the input energy prediction model.

10. The artificial intelligence apparatus of claim 1,
wherein the processor is further configured to:
based on determining that the federated model existing in the memory is similar to an input energy prediction model as a result of the similarity determination, cluster the input energy prediction model into the federated model when the processor updates the federated model; and
update the federated model through vector synthesis of the input energy prediction model and the federated model.

11. The artificial intelligence apparatus of claim 10,
wherein the processor is further configured to:
calculate a synthesized vector through synthesis of a vector of the input energy prediction model and a vector of the federated model when the processor updates the federated model; and
update the federated model based on the calculated synthesized vector.

12. The artificial intelligence apparatus of claim 10,
wherein the processor is further configured to update the federated model based on a project conflicting gradients (PCGrad) algorithm when the processor updates the federated model.

13. The artificial intelligence apparatus of claim 1,
wherein the memory is configured to store at least one federated model in which the plurality of energy prediction models having high similarity are clustered.

14. The artificial intelligence apparatus of claim 13,
wherein the memory is further configured to, based on there being a plurality of stored federated models, separate and store the federated models for each category of a prediction result provided by the federated model.

15. A method for clustering an energy prediction model at an artificial intelligence device including a memory, the method comprising:
receiving a plurality of energy prediction models comprising an energy prediction model for each household;
determining whether a federated model exists in the memory for determining a similarity between the energy prediction model for each household and the federated model;
determining the similarity between the energy prediction model for each household and the federated model based on determining that the federated model exists in the memory; and
clustering the energy prediction model for each household into the federated model according to the determined similarity to update the federated model.
